(19) United States
(12) Patent Application Publication
(10) Pub. No.: US 2015/0125019 A1
(43) Pub. Date: May 7, 2015

(54) Speaker Assembly for a Rectangular Display

(71) Applicant: Anthony Porter, Suffolk, VA (US)

(72) Inventor: Anthony Porter, Suffolk, VA (US)

(21) Appl. No.: 14/446,434

(22) Filed: Jul. 30, 2014

Related U.S. Application Data
(60) Provisional application No. 61/901,101, filed on Nov. 7, 2013.

(51) Int. Cl. H04R 1/02

(52) U.S. Cl. CPC H04R 1/028; H04R 2499/15
USPC 381/333

(57) ABSTRACT

A speaker assembly that is configured to be placed over a rectangular display screen and provide speakers along the sides thereof. The assembly comprises a left and right set of speakers disposed within the arms of an expandable frame, wherein the upper portion of the frame includes a telescoping structure to allow the distance between the arms of the frame to be changed based on the size of the display screen. The frame forms a substantial U-shape, wherein one or more speaker elements (speaker drivers, woofers, tweeters, etc.) are disposed within the arms and are joined by the telescoping upper portion of the frame. The interior portion of the frame arms may include attachment fasteners to the outer sides of the display, while audio connections extend from the rear of the arms to connect to an audio output source. The assembly is an improved audio system that consumes minimal volume.

### CROSS REFERENCE TO RELATED APPLICATION

This application claims the benefit of U.S. Provisional Application No. 61/901,101 filed on Nov. 11, 2013. The above identified patent application is herein incorporated by reference in its entirety to provide continuity of disclosure.

### BACKGROUND OF THE INVENTION

1. Field of the Invention

The present invention relates to audio speakers and structures for securing speakers to an existing display frame. More specifically, the present invention relates to audio speakers having a frame adapted to be mounted to a rectangular television or computer monitor and provide remote control thereof and secure fitment to the monitor structure.

Integrated speaker systems for both computer and televisions are suitable for their purposes and provide a means for the user to listen to audio transmissions from the computer or the associated computer. However these integrated speakers generally lack high sound quality, as the shape of the television or computer monitor frame is designed with different goals than providing the most optimum sound from the imbedded speakers. Generally the speakers are small and housed within a cavity that is not well suited or tailored for providing optimal sound quality. Because of this, the sound can be distorted, clipped, or dull, as the signals are not properly separated across the frequency range and proper amplification is not provided.

While most users will settle for this level of sound quality, other users prefer a richer sound from their speakers. Many of these users purchase large, high fidelity sound systems with different speaker types for different parts of the frequency spectrum, all driven by an amplifier/receiver. This type of audio system is ideal for the best quality experience, but is expensive and consumes considerable space within a room. Further still, a level of sophistication is required to operate the speakers and to set them up prior to use. A further drawback is their appearance within the room.

Many users fall within the middle of these two types, wherein the user would like a more fulfilling sound from their speakers, however they would not prefer to spend the expense for the high fidelity system or clutter their interior spaces with large, separated systems. For these users, simple plug and play speaker systems are ideal. These are systems that do not require amplification and can plug directly into an audio jack provided on the television or computer. These systems are generally more compact and have fewer separate components.

For those users who wish to have a clean look and minimal or modern looking television or computer monitor, while at the same time enjoying improved sound quality, a more compact and less ostentatious approach is desired. The present invention provides a user with audio capability without consuming undue space on a desktop or in a room, wherein the assembly is securable to the outer periphery of a rectangular display screen. The assembly comprises a generally U-shaped frame having an upper telescoping structure and arm portions that support speaker elements therein. The interior surfaces of the arms may include fastener elements, while the backsides of the speaker arms include audio connection that can be connected to an audio source. Overall, the assembly provides users with the ability to listen to audio without buying larger speaker assemblies or those that rest on a desktop surface. The present invention secures to a display screen and offers a clean design with minimal wasted space.

2. Description of the Prior Art

Devices have been disclosed in the prior art that relate to speaker systems and those that are supported by a television or display monitor. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Pat. No. 8,254,622 to Jiang, which discloses a portable electronic device with detachable speakers. The portable electronic device is adapted to be flanked by a first and second speaker assembly, each of which is detachably coupled thereto via a U-shaped spring along the backside of the speaker and electronic device. Audio connecting holes along the interior surface of each speaker allow the sound signals to be transferred from the electronic device to the speakers while thereattached. The Jiang device provides a novel assembly, wherein a specific electronic device and speaker type are removably coupled together. The present invention provides a standalone speaker system that can be coupled to any display or electronic device having a substantially rectangular structure, wherein the frame of the present invention comprises a U-shaped device that rests along the upper surface of the display and secures against the sides thereof.

U.S. Patent Publication No. 2010/0183186 to Noguchi discloses a speaker mounting member that is connected to the backside of a display apparatus, whereby a first and second speaker is supported along the sides of the display by a speaker mounting panel. The speaker mounting panel comprises a planar member secured to a first and second elongated movable member that is in slidable relationship with linking members along the backside of the display. The linking members are supported by mounting plates configured to be attached to the back surface of the display. In this way, the assembly can support speakers along the sides of the display and position them in relation thereto via the movable members. By contrast, the present invention contemplates an assembly that is supported along the upper surface of a display, whereby an adjustable frame rests thereagainst as the sides of the frame extend downward and sandwich the sides of the display. The present invention also is contemplated as an integrated speaker system, not a frame in and of itself for supporting a separate speaker system.

Similar to the Noguchi device is U.S. Patent Publication No. 2008/0304693 to Lau, which discloses a speaker mounting device for securing two speakers to a flat panel display, wherein two mounting brackets are attached to the rear of the display. A receiving arm secures to the brackets, which support a plurality of intermediate arms and pivot joints connected to the ends thereof for supporting a first and second speaker assembly along the sides of the display. The intermediate arms and joints allow the exact position of the speakers to be adjusted, including their height, distance from the display, and their orientation. Similar to the Noguchi device, the Lau device fails to contemplate the speaker assembly of the present invention or the frame construction thereof. The present invention secures the upper edge and sides of the display, and does not include separable brackets that would otherwise require installation effort and hand tools.

U.S. Pat. No. 6,527,237 to Harary discloses a bracket assembly for supporting side speakers and a center channel speaker. The bracket assembly pivotably supports two side speakers, while the center speaker is coupled the center of the assembly. The speakers are independently attached speakers that are supported by the bracket assembly. Wires from the speakers are routed along the bracket assembly but are otherwise exposed. Mounting balls are used for the side speakers so they can be directed in a given orientation. The Harary device, while providing a means to support speakers from a television or monitor, provides a bracket system that supports independent speakers. The present invention contemplates an enclosed assembly with built-in speaker elements within a U-shaped frame. The speakers are provided with the frame, while the Harary device is simply directed to an assembly of brackets and speaker mounts.

Similarly, U.S. Pat. No. 8,254,102 to Ye discloses a speaker mounting apparatus that includes several sliding members that are adapted to rest upon the upper portion of a display screen and support speakers along the sides thereof. A first and second supporting member support speakers from the ends of the sliding members, while the sliding members are received within a case above the display. Similar to the Harary device, the Ye device is a sliding assembly that supports independent speakers. The device is not an integrated electrical assembly as provided herein. The present invention contemplates a U-shaped frame with hollow arm members that extend downward along the sides of a display screen and house speaker elements and supporting electronic therefor, while a telescoping upper portion spans the distance therebetween and rests upon the upper surface of the display.

Finally, U.S. Pat. No. 5,947,434 to Kosmoski discloses an apparatus for mounting loudspeakers onto a display device, comprising a pair of L-shaped members that include downward extensions and a lateral extension. The downward extensions include a peg thereon for engaging an aperture disposed within a specifically designed speaker housing, which supports the housing from the downward extensions. Along the underside of the L-shaped members are resilient pads that are spaced therealong and balanced with respect to one another. These pads bear against a display surface and support the assembly around the periphery of the display. Similar to the Harary and Ye devices, the Kosmoski device provides a bracket for supporting speakers from the sides of a display, wherein external speakers are attached thereto. The present invention is an integrated assembly with built in speaker elements and supporting electronics.

The present invention provides a U-shaped, integrated speaker assembly that requires no installation or attachment of speakers to the frame of the device. The frame houses the speakers and supporting electronics, wherein the user adjust the width of the frame to accommodate the screen size and attaches the frame thereto. Once applied, the audio connections are routed to the audio source to drive the speakers. The speakers can be controlled via remote control using an infrared sensor or like remote control input receiving means, or alternatively by manual input via external controls. Overall, the device provides a sleek-looking, low profile sound system that is attachable to a display screen, such as a television or computer monitor.

It is submitted that the present invention is substantially divergent in design elements from the prior art, and consequently it is clear that there is a need in the art for an improvement to existing display attachable speaker systems. In this regard the instant invention substantially fulfills these needs.

### SUMMARY OF THE INVENTION

In view of the foregoing disadvantages inherent in the known types of display attachable speaker systems now present in the prior art, the present invention provides a new speaker assembly that can be utilized for providing convenience for the user when installing speakers to a television or computer display.

It is therefore an object of the present invention to provide a new and improved speaker assembly that has all of the advantages of the prior art and none of the disadvantages.

It is another object of the present invention to provide a speaker assembly to provide an integrated assembly, wherein a plurality of speaker elements is disposed within each of the arms of the frame, whereby the arms provide a left and right channel for audio output.

Another object of the present invention is to provide a speaker assembly that includes an expandable frame that can accommodate larger or smaller display screens, wherein the arms of the frame extend downward along the sides of the display screen and the upper portion of the frame is supported along the top of the display screen.

Yet another object of the present invention is to provide a speaker assembly that includes a telescoping upper portion and arms having optional attachment fasteners that can further secure the arms to the sides of the display screen.

Another object of the present invention is to provide a speaker assembly whose volume and operation can be controlled directly through manual input, or remotely using a remote control.

Another object of the present invention is to provide a speaker assembly that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of one contemplated design of the present invention.

FIG. 2 shows a perspective view of another contemplated design of the present invention.

FIG. 3 illustrates the expandability of the frame of the present invention.

FIG. 4 shows the speaker assembly in a working state, applied to a computer monitor.

FIG. 5 shows the speaker assembly in a working state, applied to a television display.

FIG. 6 shows a backside view of a television and the audio connections of the present invention being connected thereto to drive the speaker elements in the arms of the frame.

### DETAILED DESCRIPTION OF THE INVENTION

Reference is made herein to the attached drawings. Like reference numerals are used throughout the drawings to depict like or similar elements of the speaker assembly of the present invention. For the purposes of presenting a brief and clear description of the present invention, the preferred embodiment will be discussed as used for providing a low profile speaker system that is attachable to the upper portion of a display screen. The figures are intended for representative purposes only and should not be considered to be limiting in any respect.

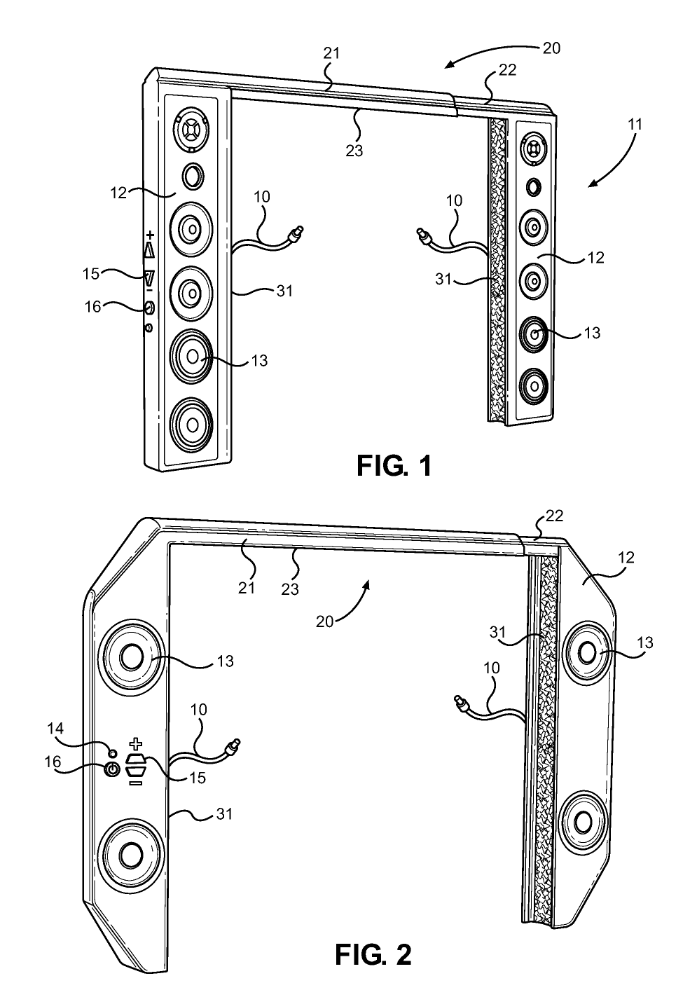

Referring now to FIGS. 1 and 2, there are perspective views of two embodiments of the present invention. The speaker assembly 11 of the present invention comprises a substantially U-shaped frame having a first and second arm member 12 extending downwardly from the frame upper portion 20. Each arm 12 comprises an enclosure that houses speaker elements 13, such as speaker drivers, woofers, tweeters, and the like, as well as associated electronics and wiring therefor. The speaker elements 13 are supported within the interior of the arm members 12 and are positioned through the front face thereof such that sounds from the speakers 13 are projected forward and towards a user facing the assembly.

The frame upper portion 20 comprises an adjustable construction, whereby the distance between the arm members 12 can be adjusted based on the condition of the frame upper portion 20. The upper portion 20 preferably comprises a telescoping construction, wherein a first telescoping member 22 is slidably positionable through a second telescoping member 23 to form a telescoping joint that can increase or decrease the gap between the arm members 12. In this way, the distance of the arm members 12 can be adjusted such that they are disposed along the sides of a display screen when the upper portion 20 is positioned over the upper edge thereof.

To drive the speaker elements 13, sound input is received from the display screen (e.g. a television or the like), from a computer, or from an audio receiver. At least one input wire 10 is provided to drive the speaker elements 13 and receive signals in the form of audio input. The input wires 10 may comprise left and right channel connections and be provided in the form of any preferred audio cable connector style known in the art (e.g. RCA audio connectors, 3.5 mm audio connectors, coaxial, etc.). When the speaker assembly 11 is positioned onto a display screen, the input wires are routed behind the screen and to an audio output port.

To assist the connection between the display screen and the speaker assembly 11, it is contemplated that a line of fasteners 31 may be positioned along the interior surfaces of the assembly 11 to maintain a firm connection with the outer periphery of the display. The fasteners 31 preferably comprise a line of hook and loop fasteners that are adapted to mate with a corresponding line of fasteners attached to the display screen. First, a strip of fasteners is adhered to the peripheral edges of the display, and thereafter the corresponding strip along the interior surfaces of the assembly 11 is pressed thereagainst as the device is mounted to the display. This prevents any forwards or rearward sliding of the assembly, particularly for flat panel and thin displays with minimal surface area around the outer edges thereof.

To control the speaker settings and the volume of the speaker elements 13, manual inputs 15, 16 are provided along at least one arm 12 of the assembly. This allows a user to manually control the volume or sound setting of the speakers, including volume 15, operation 16, and other settings that may be provided (e.g. base and treble settings, balance, etc.). The manual inputs may include inputs for several different types of settings, or may be a basic array of controls such as volume control 15 and master ON/OFF 16.

In addition to the manual inputs, it is contemplated that the speaker assembly of the present invention support remote control inputs. A remote control receiver sensor 14 may be positioned along the front surface of the assembly, whereby line of sight signals are captured (e.g. infrared signals, radio signals, etc.) from a remote control and interpreted. Supporting electronics interpret the signal and make the desired change to the audio from the speakers, such as adjusting the volume or audio settings thereof.

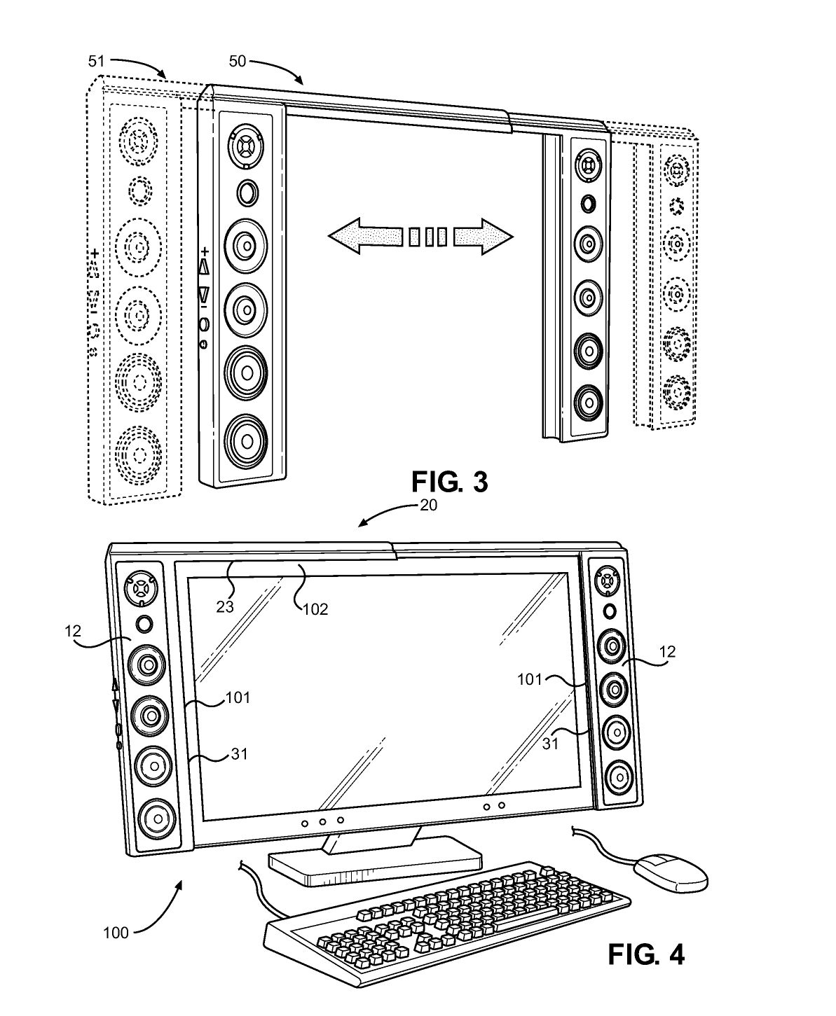

Referring now to FIGS. 3 through 5, there are shown views of the speaker assembly of the present invention in an working state, whereby the distance between the arm members 12 of the frame are adjusted to a desired offset before being placed over the upper periphery and along the sides of a display device. FIG. 3 illustrates how the upper portion of the frame telescopes, allowing for adjustment of the device from a first configuration 50 to a second configuration 51. FIG. 4 illustrates a view of the speaker assembly positioned onto a computer monitor 100, whereby the upper portion 20 of the frame is positioned over the upper edge 102 of the monitor, and the arm members 12 are positioned along the side edges 101 of the monitor. To assist this connection, the fastener connection 31 along the inner surface of the arms 12 and the sides 101 of the monitor 100 secures the frame in a stable condition.

In a similar manner, the speaker assembly of the present invention is suited for connection to a flat panel television 110, as illustrated in FIG. 5. The width of the frame is adjusted along the upper portion 20 such that the arm members 12 extend along the sides 11 of the television and the upper portion 20 is disposed along the upper edge 112 thereof. Once positioned, the telescoping upper portion 20 can be drawn together such that the arm members 12 bear against the sides 111 of the television and the fastener attachment 31 further stabilizes the assembly thereagainst.

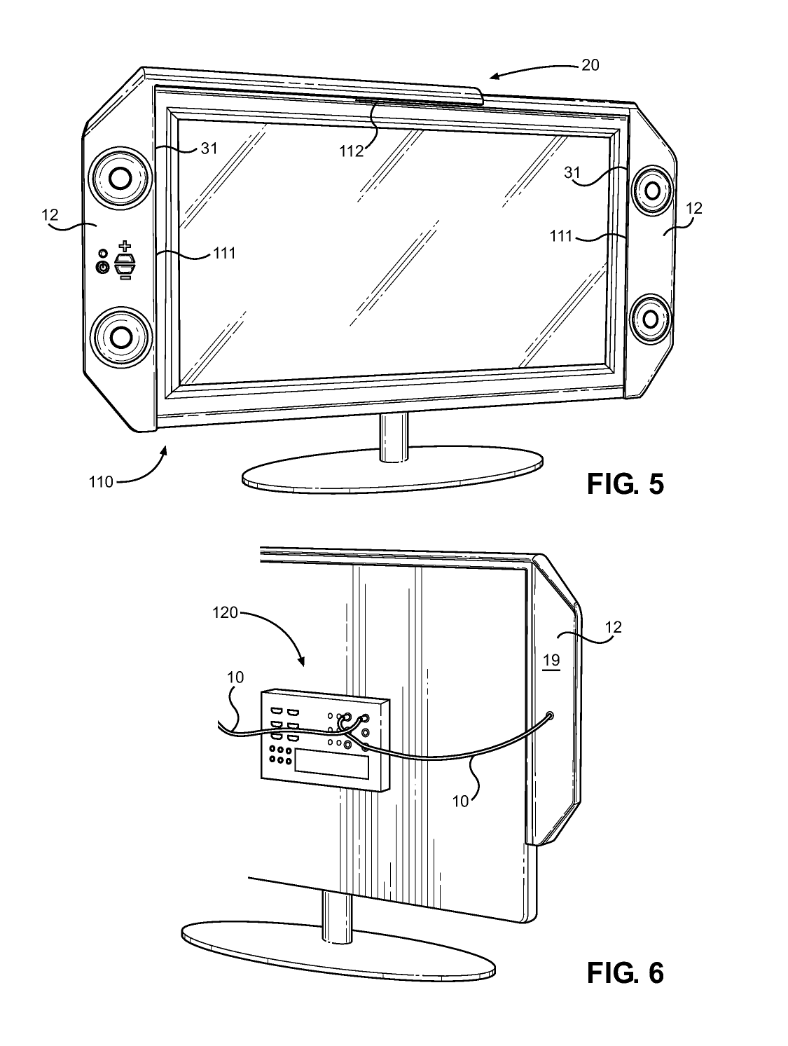

Referring finally to FIG. 6, there is shown an illustration of the audio input wires 10 that are used to connect to an audio source along the backside of the display device. In the embodiment as shown, a first and second input wire 10 is connected to the audio output ports 120 of a television, whereby the speakers are driven by the audio output from the television. The input wires 10 preferably extend from the rear surface 19 of the arms and include an elongated length to connect along the rear of a television, or alternatively to a computer or audio system receiver adjacent to the display device.

Conventional amplification systems generally require audio equipment to be installed around a room, which can be complicated and require significant space. Even systems that are more simple to setup take up considerable space on tables or floors, which is inconvenient and impractical. The present invention describes a set of speakers for use with a television or a computer monitor. The device includes left and right speaker housings (frame arms) that are positioned on the sides of the television or monitor. The arms include cutouts for speakers, manual and/or remote receiver inputs, and an interior volume to support the speakers and supporting electronics therein. The upper portion of the frame extends across the top of the television or monitor and secures the speakers in position for use. The speaker system provides users with a set of speakers for existing computer screens and televisions, amplifying the audio therefrom to enhance the experience for users. Additionally, the device eliminates the need to install complicated audio equipment around a room. The present invention accommodates conventional and flat screen displays and includes an adjustable connection for differently sized displays.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A speaker assembly adapted to secure over the upper surface and sides of a display device, comprising:
a substantially U-shaped frame comprising an upper portion and a first and second arm member;
said upper portion having ends and the first and second arm member extending substantially perpendicularly from said ends;
said first and second arm member comprising a front surface, an interior volume, and an interior surface;
a plurality of speaker elements disposed within said interior volume of each arm member, said speaker elements being positioned through cutouts in said front surface thereof;
at least one audio input wire extending from one or both of said first and second arm member for driving said speaker elements;
said upper portion of said U-shaped frame comprising a first telescoping member and a second telescoping member disposed in a telescoping relationship with regard to one another such that the length of said upper portion is adjustable.

2. The speaker assembly of claim 1, wherein said interior surface of said first and second arm member comprises a hook and loop fastener material thereon.

3. The speaker assembly of claim 1, further comprising manual input controls for adjusting said speaker elements.

4. The speaker assembly of claim 1, further comprising a remote control input sensor for adjusting said speaker elements.
